(19) United States
(12) Patent Application Publication
(10) Pub. No.: US 2011/0175297 A1
(43) Pub. Date: Jul. 21, 2011

(54) MECHANICAL SEAL ASSEMBLY HAVING FILTER MEMBER

(76) Inventors: Andreas Fesl, Otterfing (DE); Peter Dröscher, Geretsried (DE)

(21) Appl. No.: 12/737,471

(22) PCT Filed: Jul. 15, 2009
(86) PCT No.: PCT/EP2009/005150

§ 371 Date: Mar. 16, 2011

(30) Foreign Application Priority Data
Jul. 22, 2008 (DE) 20 2008 009 842.4

(51) Int. Cl. F16J 15/34

(52) U.S. Cl. 277/358

(57) ABSTRACT

The invention relates to a slide ring seal arrangement comprising: a first stationary slide ring (2) having a first slide surface (2a), a second rotating slide ring (3) having a second slide surface (3a), wherein the rotating slide ring (3) rotates together with a rotating component (10) and wherein the slide surfaces (2a, 3a) of the slide rings (2, 3) are disposed opposite of each other and define a sealing gap (4) between each other, a dynamic secondary seal (13) that is arranged on a side (2b) of the stationary slide ring (2) facing away from the sealing gap (4) and seals a housing sealing region (12), a pretensioning device (7) that applies a pretension in the axial direction onto the stationary slide ring (2), and a filter element (14; 24) that has a substantially ring shape and is arranged in the radial direction further from a rotational axis (X-X) than the housing sealing region (12), in order to prevent dirt particles from depositing on the secondary seal (13) or on the housing sealing region (12).

The present invention relates to a mechanical seal assembly having a filter member to prevent dirt from depositing at a dynamic secondary seal of the mechanical seal assembly.

Mechanical seal assemblies are known from the state of the art in different forms. Apart from high stress due to temperature and pressure, it is a further problem that often the medium, which is sealed by means of the mechanical seal assembly, is not completely pure, but comprises dirt particles.

Such dirt particles deposit in particular at a dynamic secondary seal which follows axial compensation movements of a seal ring. In particular, deposits are also possible on a raceway of the dynamic secondary seal. Such dirt deposits can result in a wear at the hydraulic diameter or a blockage of the secondary seal in case a pretensioning force is transmitted through the dynamic secondary seal. Consequently, in a worst case scenario, a complete failure of the mechanical seal assembly may occur.

It is therefore an object of the present invention to provide a mechanical seal assembly which avoids the problems of dirt, which can result in a failure of the mechanical seal assembly, while having a simple structure and being manufactured easily and cost-effectively.

This object is solved by a mechanical seal assembly having the features of claim 1. The sub-claims show preferred further developments of the invention.

The inventive mechanical seal assembly having the features of claim 1 prevents a deposition of dirt particles such that an interference of the function of the mechanical seal assembly due to deposited dirt particles can be prevented. According to the invention, a filter member is provided for this purpose, which has a ring shape and which is disposed in a radial direction further outwardly than a housing sealing region. At this housing sealing region, a dynamic secondary seal seals a rear side of a static seal ring facing away from a sealing gap. The static seal ring is not rotating (rotationally fixed) and can be moved axially by a pretensioning device in order to maintain a sealing gap between the stationary seal ring and the rotating seal ring as small as possible. According to the invention, it is in particular prevented that deposits form at the dynamic secondary seal, which deposits could result in leakage of the dynamic secondary seal and could especially prevent a motion of the dynamic secondary seal in an axial direction. This immobility in the axial direction, also referred to as “hang-up”, affects in particular a pretensioning function of the pretensioning device, in case the pretension is transferred via the dynamic secondary seal. Further, it is prevented that an undesired wear at the hydraulic diameter of the dynamic secondary seal occurs due to the deposition of dirt particles. The inventive solution therewith enables a simple and cost-effective prevention of a deposition of dirt particles at undesired portions of the mechanical seal assembly by providing the ring-shaped or annular filter member. Therewith, the inventive mechanical seal assembly has a considerably smaller failure probability and in particular also an increased service life. Therewith, the inventive mechanical seal assembly may also be used with polluted media, however, no separate inhibiting fluid circuit has to be provided for the mechanical seal assembly.

In order to be able to filter out and absorb dirt particles present in the medium as good as possible, the annular filter member preferably comprises a circumferential recess which is directed radially inwardly. Therewith, the dirt particles can be received and accumulated in the circumferential recess. Further, even in case of an accumulation of a larger amount of dirt particles at the lateral wall portions of the recess, sufficient free filter surface still remains, which secures a flow of medium through the filter medium. Preferably, the recess has a U-shape in cross-section.

Preferably, the pretensioning device comprises a thrust ring which transfers a thrust force via the dynamic secondary seal to the stationary seal ring. Particularly preferably, one side of the filter member is fixed at the thrust ring and the other side thereof is fixed at a housing component.

As the filter member, preferably a non-woven fabric (fleece) is used, wherein the non-woven fabric further has a mesh density of preferably 0.7 μm to 1.3 μm and even more preferably a mesh density of 1 μm.

Preferably, the filter member is made of a one-piece non-woven fabric. As an alternative, the filter member may also be made of two annular layers of non-woven fabric, the surfaces of which are oriented in the axial direction, by connecting at least two layers of non-woven fabric at a periphery, preferably the inner periphery. Particularly preferably, the filter member is made of exactly four layers of non-woven fabric and, in this case, substantially has a M-shape in cross-section.

Particularly preferred, the filter member is pressure-permeable, i.e. a pressure in front of the filter member corresponds to a pressure behind the filter member. Consequently, an identical pressure exists in the area in front of and behind the filter member, such that in particular a proper function of the secondary seal can be secured.

For a simple and fast assembly, the filter member is preferably fixed by an adhesive connection at its both ends being free in the axial direction.

The inventive mechanical seal assembly is particularly preferably used for gaseous media and is embodied as a gas-lubricated mechanical seal assembly. The inventive mechanical seal assembly may e.g. be used in compressors for natural gas or the like.

In the following, preferred embodiments of the invention are described in detail with reference to the accompanying drawing, in which:

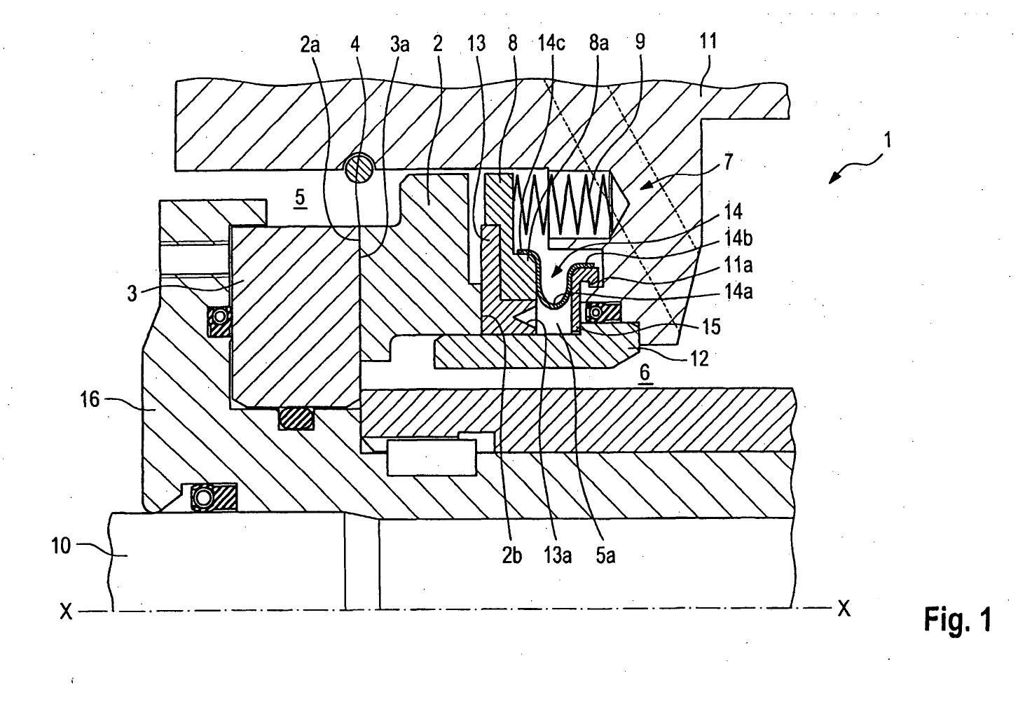

FIG. 1 shows a schematic sectional view of a mechanical seal assembly 1 according to a first embodiment of the invention, and

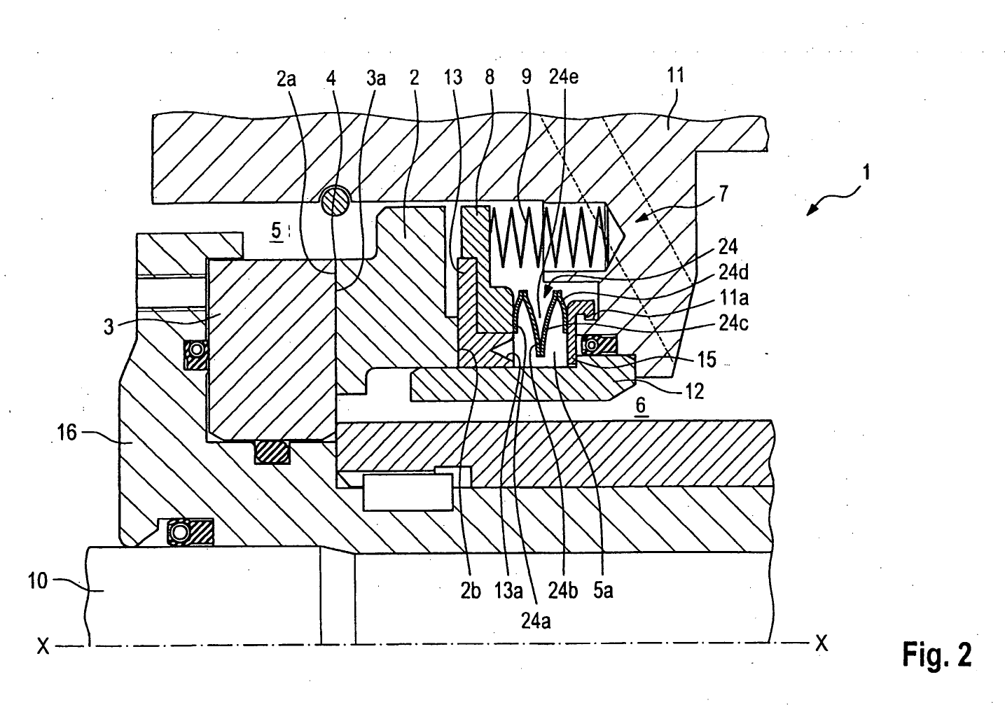

FIG. 2 shows a schematic sectional view of a mechanical seal assembly 2 according to a second embodiment of the invention.

In the following, a mechanical seal assembly 1 according to a first embodiment of the invention is described with reference to FIG. 1

As is discernible from FIG. 1, the mechanical seal assembly 1 comprises a first stationary seal ring 2 and a second rotating seal ring 3. The rotating seal ring 3 is connected to a shaft 10 through a sleeve 16 and rotates together with the shaft 10 and the sleeve 16 about a rotational axis X-X. The two seal rings 2, 3 have sliding surfaces 2a, 3a opposing each other, which define a sealing gap 4 between them.

The mechanical seal assembly 1 herein seals between a first chamber 5 and a second chamber 6 at the rotating shaft 10. This embodiment refers to a gas-lubricated mechanical seal assembly which is configured to seal a gaseous medium present in chamber 5.

Further, the mechanical seal assembly 1 comprises a pretensioning device 7 including a thrust ring 8 and a plurality of pretensioning springs 9 which are circumferentially distributed. The pretensioning device 7 pretensions the stationary seal ring 2 against the rotating seal ring 3. In this context, it shall be noted that the term “stationary” shall mean that the second seal ring 2 has a possibility to move in the axial direction due to the pretensioning force of the pretensioning device transferred to said ring, in order to maintain a sealing gap 4 between the seal rings 2, 3, which gap is defined to be as narrow as possible. With regard to the rotating seal ring, the stationary seal ring 2 is arranged rotationally fixed.

The pretensioning springs 9 of the pretensioning device 7 are arranged in boreholes in the housing 11 in this embodiment. Further, a sleeve-shaped housing sealing region 12 is arranged at the housing 11, at which region the stationary seal ring 2 is supported. The housing sealing region 12 is formed as a sleeve which is preferably made of a tungsten-carbide-material. Therewith, a high durability against high pressures of the medium to be sealed can be achieved. Further, a dynamic secondary seal 13 is arranged at this housing sealing region 12 at a rear side 2b of the stationary seal ring 2, which is disposed opposite to the sliding surface 2a in an axial direction. As is discernible from FIG. 1, the dynamic secondary seal 13 is arranged between the stationary seal ring 2 and the thrust ring 8. Therewith, a pretensioning force of the pretensioning device 7 is transmitted via the thrust ring 8 to the stationary seal ring 2. As is further discernible from FIG. 1, the dynamic secondary seal has a L-shape in cross-section and further comprises a V-shaped insert 13a at the leg disposed in the axial direction, which insert is oriented in the axial direction.

Further, the inventive mechanical seal assembly 1 comprises a filter member 14 which substantially has a ring shape and is arranged at a position radially more outwardly than the housing sealing region 12. The filter member 14 is made of a non-woven fabric and has a pore size of 1 μm. As is discernible from FIG. 1, the filter member 14 has a U-shape in cross-section including a radially inwardly directed recess 14a, a first fixing portion 14b and a second fixing portion 14c. As is shown in FIG. 1, the filter member 14 is attached at a shoulder 8a of the thrust ring 8 and a ring member 15 attached at the housing 11. The attachment of the filter member 14 at the fixing portions 14b, 14c is preferably performed by an adhesive connection. As is discernible from FIG. 1, the filter member 14 separates a portion 5a from the first chamber 5. The portion 5a is disposed radially inside the filter member 14 and in particular at a sealing area between the dynamic secondary seal 13 and the housing sealing portion 12. The circumferential recess 14a of the filter member 14 serves to receive and accumulate dirt particles which are present in the gaseous medium.

Equal pressures exist in chamber 5 and portion 5a, since the filter member 14 is pressure-permeable. Therewith, in particular, also pressure changes in chamber 5 can be transmitted without delay to the portion 5a behind the filter member 14. Thus, the filter member 14 does in no way affect the function of the mechanical seal assembly. Consequently, a pressing force of the stationary seal ring 2 against the rotating seal ring 3 can be maintained.

For fixing the ring member 15, an undercut 11 a is formed at the housing 11, such that the ring member 15 can be attached at the housing 11 by means of a clipping step.

According to the invention, it may thus be prevented that dirt particles deposit, in particular at the housing sealing region 12, which could effect an interference of a free motion of the secondary seal 13 and the stationary seal ring 2 in an axial direction. The filter member 14 therefore secures a free spring backing of the stationary seal ring 2. Due to the U-shape of the filter member 14 in cross-section, also no limitation of a mobility of the secondary seal 13 occurs, since the filter member 13 can perform a compensation movement in the axial direction.

Since the filter element 14 is arranged relatively near to the housing sealing region 12, it is further prevented that e.g. a deposition of particles occurring only in the area of the mechanical seal assembly is possible. The inventive filter member does not restrict the axial mobility of the mechanical seal assembly and is also gas-permeable due to the mesh density of approximately 1 μm. Apart from dirt particles, the filter member can of course also filter out liquid particles which may also lead to disturbances in the area of the secondary seal 13.

In this embodiment, the filter member 14 is attached at the first and second fixing portions 14b, 14c by means of an adhesive connection. It shall be noted that the filter member can e.g. also be attached by clamping the fixing portions 14b, 14c as an alternative. However, the embodiment including the adhesive connection in particular between the first fixing portion 14b and the ring member 15 has the advantage that same can be performed already prior to a mounting of the mechanical seal assembly. For mounting the mechanical seal assembly, only the ring member 15 has to be clipped over an undercut 11 a provided at the housing 11.

In the following, a mechanical seal assembly 2 according to a second embodiment of the invention is described with reference to FIG. 2, wherein identical parts or parts having the same function are designated with reference numerals identical to those of the first embodiment.

The mechanical seal assembly 2 substantially corresponds to the first embodiment, however, contrary thereto, the filter member is formed differently. In the second embodiment, the filter member is designated with reference numeral 24. The filter member 24 is made of four layers of non-woven fabric 24a, 24b, 24c, 24d. In this context, the two outer layers 24a and 24d serve to fix the filter member and the two inner layers 24b and 24c form a collection portion having a V-shape in cross-section, in which dirt particles and/or liquid drops can be collected. The individual layers of non-woven fabric are respectively inter-connected by glueing. Therewith, the filter member of the second embodiment has a M-shape in cross-section. By connecting adjacent layers of non-woven fabric respectively at a boundary area thereof, the filter member 24 of the second embodiment has a somewhat stiffer design, without restricting the axial mobility of the filter member, such that the filter member 24 of the second embodiment can surely retain its shape. Apart from this, this embodiment corresponds to the preceding embodiment, such that reference can be made to the description given in said context.

1. A mechanical seal assembly, comprising:
a first stationary seal ring having a first sliding surface,
a second rotating seal ring having a second sliding surface (3a), wherein the rotating seal ring rotates together with a rotating component and wherein the sliding surfaces of the seal rings are disposed opposite to each other and define a sealing gap between them,
a dynamic secondary seal which is arranged at a side of the stationary seal ring facing away from the sealing gap and seals at a housing sealing region,
a pretensioning device that applies a pretension onto the stationary seal ring in an axial direction, and
a filter member which substantially has a ring shape and which is arranged in the radial direction further away from a rotational axis (X-X) than the housing sealing region, in order to prevent dirt particles from depositing on the secondary seal or the housing sealing region.

2. The mechanical seal assembly of claim 1, wherein the filter member comprises a radially inwardly directed, circumferential recess for accumulating dirt particles.

3. The mechanical seal assembly of claim 1, wherein the pretensioning device comprises a thrust ring and a plurality of spring members, wherein the thrust ring contacts the secondary seal and a pretensioning force of the spring members can be transmitted through the thrust ring to the stationary seal ring.

4. The mechanical seal assembly of claim 3, wherein the filter member is attached at the thrust ring and at a housing or a component connected to the housing.

5. The mechanical seal assembly of claim 3, wherein the thrust ring has an annular shoulder at which the filter member is fixed.

6. The mechanical seal assembly of claim 1, wherein the filter member is attached by means of an adhesive connection.

7. The mechanical seal assembly of claim 1, wherein the filter member is a non-woven fabric or a textile network.

8. The mechanical seal assembly of claim 1, wherein the filter member is a non-woven fabric having a mesh density between 0.7 μm and 1.3 μm, preferably 1 μm.

9. The mechanical seal assembly of claim 7, wherein the filter member is formed of a one-piece non-woven fabric.

10. The mechanical seal assembly of claim 7, wherein the filter member is made of at least two layers of non-woven fabric which are connected to each other at a circumferential lateral edge.

11. The mechanical seal assembly of claim 10, wherein the filter member is made of exactly four layers of non-woven fabric and has a M-shape in cross-section, and in particular has a U-shape in cross-section.

12. The mechanical seal assembly of claim 1, wherein the filter member is pressure-permeable.
